(19) United States
(12) Patent Application Publication
(10) Pub. No.: US 2026/0109016 A1
(43) Pub. Date: Apr. 23, 2026

(54) WRENCH

(71) Applicant: William Tools Co., Ltd., Taichung City (TW)

(72) Inventor: Shui-Lai Chiang, Taichung City (TW)

(21) Appl. No.: 19/272,226

(22) Filed: Jul. 17, 2025

(30) Foreign Application Priority Data
Oct. 18, 2024 (TW) 113139729

(51) Int. Cl. B25G 3/38; B25B 13/46

(52) U.S. Cl. CPC B25G 3/38; B25B 13/46

(57) ABSTRACT

A wrench is provided, wherein the wrench includes: a main body; a driving head swingably connected to the main body; and a control mechanism including a control member movably disposed on the main body, and a positioning assembly including a locking member and a positioning unit, one of the locking member and the control member including the positioning unit, and the other of the locking member and the control member including a first positioning portion and a second positioning portion which have different depths; wherein when the control member is located in a locking position, the positioning unit engages in the first positioning portion and the driving head is non-rotatable, and when the control member is located in a release position, the positioning unit engages in the second positioning portion and the driving head is rotatable.

### BACKGROUND OF THE INVENTION

### Field of the Invention

The present invention relates to a driving tool, particularly to a wrench.

### Description of the Prior Art

In conventional wrenches, the handle and the driving head are integrally formed. However, because such integrally formed wrenches cannot be adjusted in angle, users often encounter operational difficulties in narrow spaces (such as automotive engine compartments, inside industrial equipment, pipelines, etc.) or when special angle operation is required, thereby affecting operational flexibility.

The present invention is, therefore, arisen to obviate or at least mitigate the above-mentioned disadvantages.

### SUMMARY OF THE INVENTION

The main object of the present invention is to provide a wrench that allows adjustment of the swinging angle of a driving head and positioning at a selected angle.

To achieve the above and other objects, a wrench is provided, wherein the wrench includes: a main body; a driving head connected to the main body and swingable about a pivot axis; and a control mechanism including a control member and a positioning assembly, the control member being disposed on the main body and movable between a locking position and a release position, the positioning assembly including a locking member and a positioning unit which are movable relative to each other, one of the locking member and the control member including the positioning unit, and the other of the locking member and the control member including a first positioning portion and a second positioning portion which have different depths; wherein when the control member is located in the locking position, the positioning unit engages in the first positioning portion to orient the locking member toward the driving head to restrict rotation of the driving head, and when the control member is located in the release position, the positioning unit engages in the second positioning portion to allow the locking member to move away from the driving head such that the driving head is rotatable; wherein the positioning unit is configured to engage in the first positioning portion or in the second positioning portion in a first direction, the control member includes a first stepped portion and a second stepped portion, in the first direction a depth of the first stepped portion is smaller than a depth of the second stepped portion, when the control member is located in the locking position, the locking member abuts against the first stepped portion in the first direction, when the control member is located in the release position, the locking member corresponds to the second stepped portion and is normally spaced from the second stepped portion, and the first direction is perpendicular to the pivot axis.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a first exemplary embodiment of the present invention;

FIG. 2 is an exploded view of the first exemplary embodiment of the present invention;

FIG. 3 is another exploded view of the first exemplary embodiment of the present invention;

FIG. 4 is a cross-sectional view of the first exemplary embodiment of the present invention;

FIG. 5 is a schematic view showing a control member in a release position in the first exemplary embodiment of the present invention;

FIG. 6 is a schematic view showing a driving head swinging in the first exemplary embodiment of the present invention;

FIG. 7 is a schematic view of a second exemplary embodiment of the present invention; and

FIG. 8 is a schematic view of a third exemplary embodiment of the present invention.

### DETAILED DESCRIPTION OF THE PREFERRED EMBODIMENTS

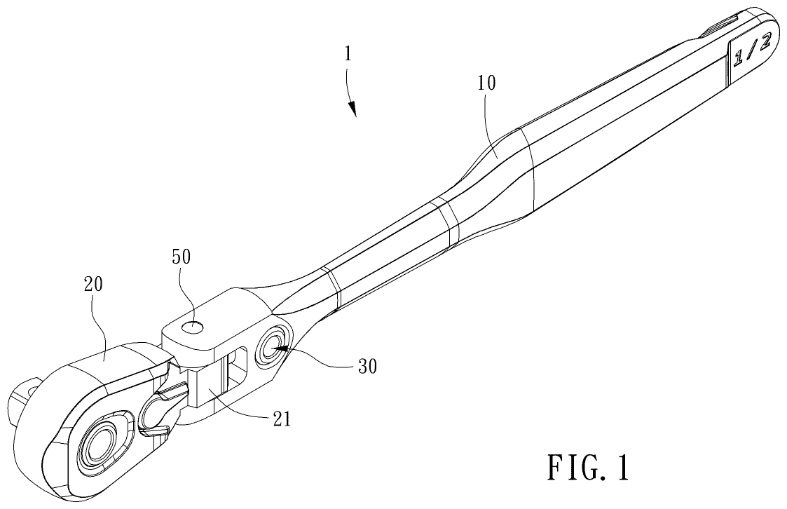

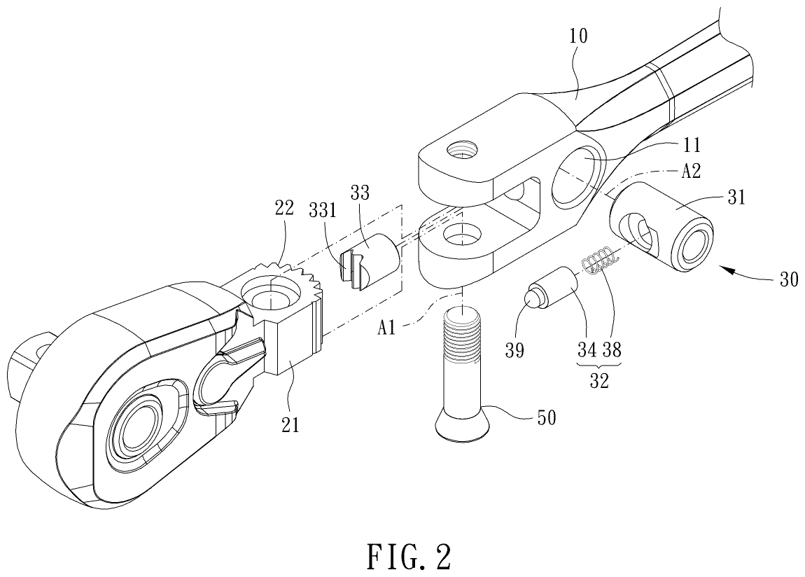

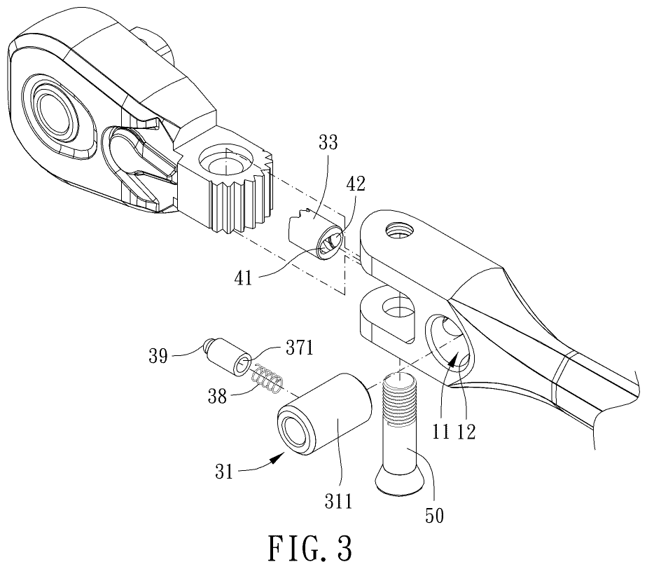

Please refer to FIGS. 1 to 6 for an exemplary embodiment of the present invention. A wrench 1 of the present invention includes a main body 10, a driving head 20, and a control mechanism 30.

The driving head 20 is connected to the main body 10 and swingable about a pivot axis A1. In this embodiment, the wrench 1 further includes a shaft 50 which is disposed through the main body 10 and the driving head 20. The shaft 50 defines the pivot axis A1, allowing the driving head 20 to swing stably.

The control mechanism 30 includes a control member 31 and a positioning assembly 32. The control member 31 is disposed on the main body 10 and movable between a locking position and a release position. The positioning assembly 32 includes a locking member 33 and a positioning unit 34 which are movable relative to each other. One of the locking member 33 and the control member 31 includes the positioning unit 34, and the other of the locking member 33 and the control member 31 includes a first positioning portion 41 and a second positioning portion 42 having different depths. In this embodiment, the depth of the first positioning portion 41 is smaller than the depth of the second positioning portion 42. The first positioning portion 41 and the second positioning portion 42 are disposed at one end of the locking member 33. The positioning unit 34 is disposed at one end of the control member 31.

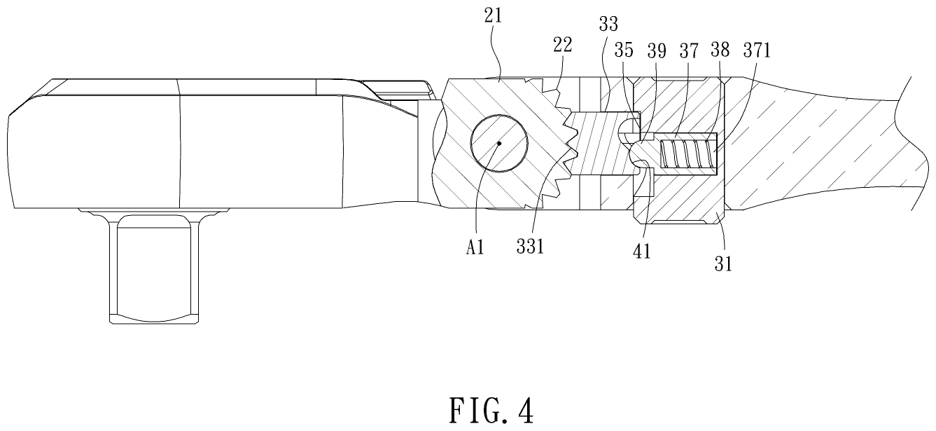

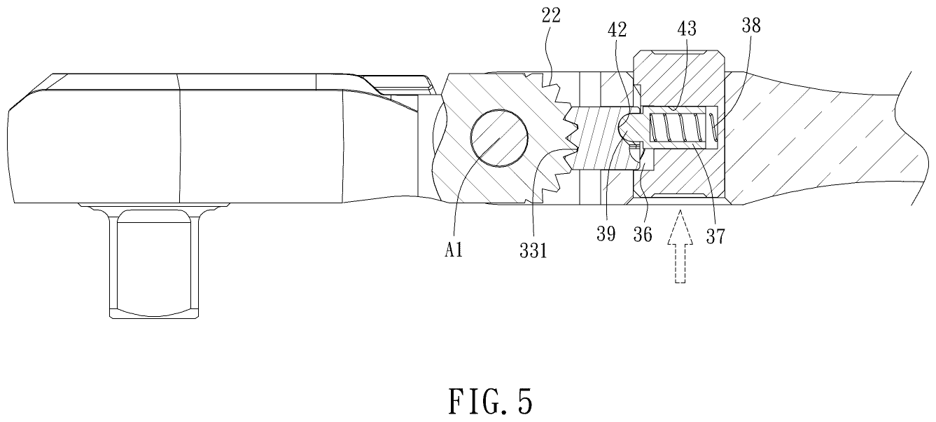

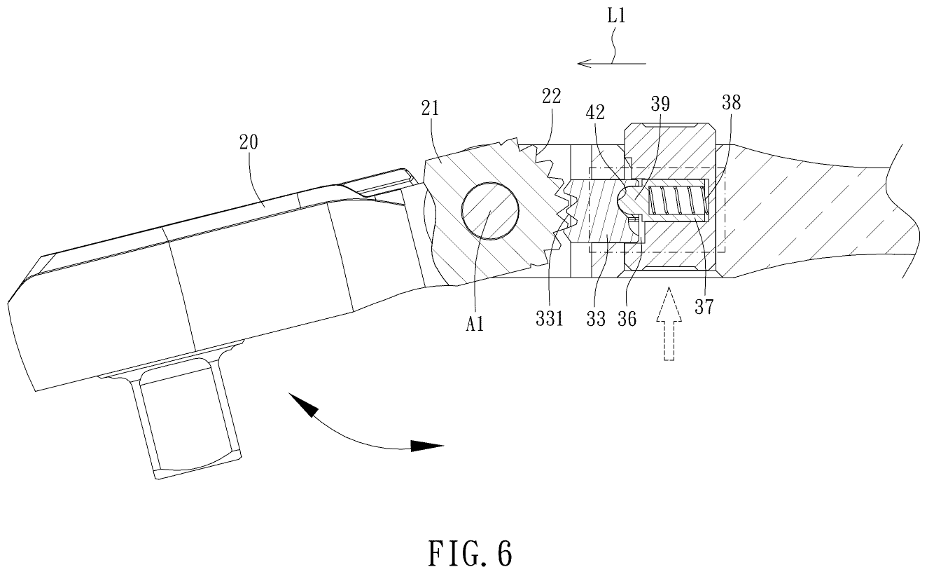

When the control member 31 is located in the locking position (FIG. 4), the positioning unit 34 engages in the first positioning portion 41 to orient the locking member 33 toward the driving head 20, thereby restricting rotation of the driving head 20. When the control member 31 is located in the release position (FIGS. 5 and 6), the positioning unit 34 engages in the second positioning portion 42, allowing the locking member 33 to move away from the driving head 20 such that the driving head 20 is freely rotatable.

Thus, the control member 31 can be switched to the locking position or the release position with one hand. After releasing the hand, the control member 31 remains in the locking position or the release position without needing to be held continuously. Moreover, the driving head 20 can be swung relative to the main body 10 to a predetermined position and then positioned by the positioning assembly 32. Since the locking member 33 and the positioning unit 34 are separate independent components, they offer high flexibility in positioning, easy assembly and maintenance, and the ability to be replaced or customized as needed, which facilitates integration of different locking members 33 or positioning units 34.

The positioning unit 34 is configured to engage in the first positioning portion 41 or the second positioning portion 42 in a first direction L1. The control member 31 includes a first stepped portion 35 and a second stepped portion 36. In the first direction L1, the depth of the first stepped portion 35 is smaller than the depth of the second stepped portion 36. When the control member 31 is located in the locking position, the locking member 33 abuts against the first stepped portion 35 in the first direction L1. When the control member 31 is located in the release position, the locking member 33 corresponds to the second stepped portion 36 and is normally spaced from the second stepped portion 36. The first direction L1 is perpendicular to the pivot axis A1. In this embodiment, the second stepped portion 36 includes the first positioning portion 41 and the second positioning portion 42. Therefore, the locking member 33 can be simultaneously engaged by the first stepped portion 35 and the positioning assembly 32 toward the driving head 20, making it unable to move away from the driving head 20. Hence, the locking member 33 is stably positioned by multiple contact points. In the release position, the locking member 33 disengages from the first stepped portion 35, corresponds to the second stepped portion 36, and can reciprocate in the first direction L1 relative to the second stepped portion 36.

The positioning unit 34 includes a positioning member 37 and an elastic member 38. The positioning member 37 includes a column and a detent portion 39 integrally connected with each other. One of the control member 31 and the locking member 33 includes a recess 43 recessed in the first direction L1, and the positioning unit 34 is disposed in the recess 43. The detent portion 39 is selectively engageable in the first positioning portion 41 or the second positioning portion 42. Specifically, the column includes a receiving slot 371, and the elastic member 38 is disposed in the receiving slot 371 and elastically abuts against the control member 31 or the locking member 33. Thus, the outer circumference of the column can be in close contact with the control member 31 or the locking member 33, providing a large contact area, while the elastic member 38 does not contact the control member 31 or the locking member 33. This allows the positioning member 37 to be stably supported in a direction transverse to the first direction L1, preventing lateral deviation. In this embodiment, the outer diameter of the column is greater than the outer diameter of the detent portion 39.

The detent portion 39 is arcuately convex, and the first positioning portion 41 and the second positioning portion 42 are arcuate recesses (in other embodiments, they may be through inclined surfaces or flat surfaces). The detent portion 39 is selectively engageable in the first positioning portion 41 or the second positioning portion 42. When the detent portion 39 abuts the first positioning portion 41 or the second positioning portion 42, the applied force is evenly distributed, resulting in stable support. The positioning member 37 can also be compressed and stably move along the first direction L1. Furthermore, in this embodiment, the first positioning portion 41 and the second positioning portion 42 are blind holes, but in other embodiments, they may be through structures.

The driving head 20 includes a neck portion 21 protruding outwardly. The neck portion 21 has a first toothed portion 22 extending about the pivot axis A1, and the locking member 33 includes a second toothed portion 331 configured to mesh with the first toothed portion 22. Accordingly, the second toothed portion 331 of the locking member 33 can mesh with the first toothed portion 22 to position the driving head 20 at a predetermined angle. It is also possible to disengage the teeth to adjust the angle of the driving head 20 while it swings.

The main body 10 has a through hole 11 disposed through opposite sides thereof, and the control member 31 is movably disposed in the through hole 11. The through hole 11 defines a center axis A2 which is perpendicular to the pivot axis A1. This facilitates pressing the control member 31 from both opposite sides of the through hole 11 to the locking position or the release position. In this embodiment, the control member 31 includes a first smooth surface 311 on the side opposite to a side the positioning assembly 32 is disposed. The main body 10 includes a second smooth surface 12 which includes the through hole 11. The first smooth surface 311 abuts the second smooth surface 12, allowing full contact between the control member 31 and the main body 10, resulting in a large contact area, strong support, high operational stability, and increased friction to prevent unintentional movement of the control member 31 under external forces.

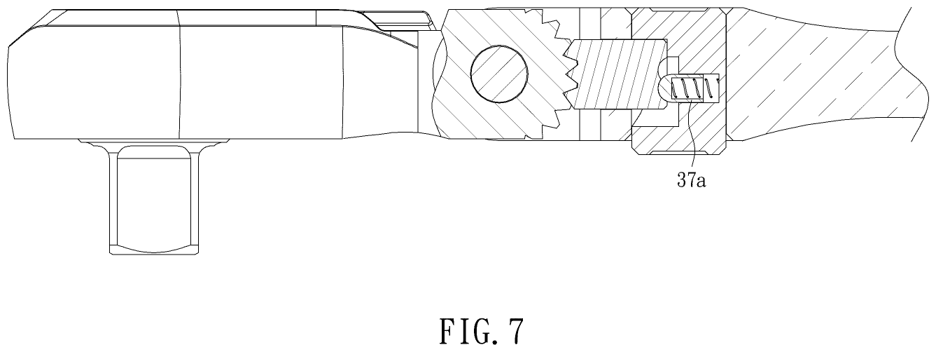

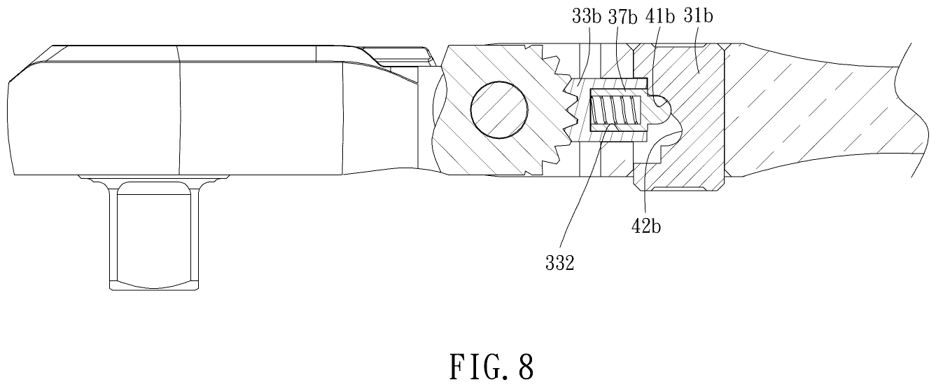

Please refer to FIG. 7, which shows a second exemplary embodiment of the present invention. It differs from the first exemplary embodiment in that the positioning member 37a is bullet-shaped. Please refer to FIG. 8 which shows a third exemplary embodiment of the present invention. The locking member 33b includes the receiving slot 332, and the positioning member 37b is movably disposed through the receiving slot 332. The first positioning portion 41b and the second positioning portion 42b are disposed on the control member 31b. In other embodiments, the positioning unit may be swingably pivoted to the locking member in the form of a toggle lever.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A wrench including:
a main body;
a driving head connected to the main body and swingable about a pivot axis; and
a control mechanism including a control member and a positioning assembly, the control member being disposed on the main body and movable between a locking position and a release position, the positioning assembly including a locking member and a positioning unit which are movable relative to each other, one of the locking member and the control member including the positioning unit, and the other of the locking member and the control member including a first positioning portion and a second positioning portion which have different depths;
wherein when the control member is located in the locking position, the positioning unit engages in the first positioning portion to orient the locking member toward the driving head to restrict rotation of the driving head, and when the control member is located in the release position, the positioning unit engages in the second positioning portion to allow the locking member to move away from the driving head such that the driving head is rotatable;
wherein the positioning unit is configured to engage in the first positioning portion or in the second positioning portion in a first direction, the control member includes a first stepped portion and a second stepped portion, in the first direction a depth of the first stepped portion is smaller than a depth of the second stepped portion, when the control member is located in the locking position, the locking member abuts against the first stepped portion in the first direction, when the control member is located in the release position, the locking member corresponds to the second stepped portion and is normally spaced from the second stepped portion, and the first direction is perpendicular to the pivot axis.

2. The wrench of claim 1, wherein the positioning unit includes a positioning member and an elastic member, the positioning member includes a column and a detent portion integrally connected with each other, and one of the control member and the locking member includes a recess recessed in the first direction, the positioning unit is disposed in the recess, and the detent portion is selectively engageable in the first positioning portion or in the second positioning portion.

3. The wrench of claim 2, wherein the column includes a receiving slot, and the elastic member is disposed in the receiving slot and elastically abuts against the control member or the locking member.

4. The wrench of claim 3, wherein the detent portion is arcuately convex, the first positioning portion and the second positioning portion are arcuate recesses, and the detent portion is selectively engageable in the first positioning portion or in the second positioning portion.

5. The wrench of claim 1, wherein the main body has a through hole disposed through opposite sides thereof, the control member is movably disposed in the through hole, and the through hole defines a center axis perpendicular to the pivot axis.

6. The wrench of claim 5, wherein the control member includes a first smooth surface on a side opposite to a side where the positioning assembly is disposed, the main body includes a second smooth surface including the through hole, and the first smooth surface abuts the second smooth surface.

7. The wrench of claim 1, wherein the depth of the first positioning portion is less than the depth of the second positioning portion.

8. The wrench of claim 1, further including a shaft, wherein the shaft is disposed through the main body and the driving head, and the shaft defines the pivot axis.

9. The wrench of claim 2, wherein the column includes a receiving slot, the elastic member is disposed in the receiving slot and elastically abuts against the control member or the locking member; the detent portion is arcuately convex, the first positioning portion and the second positioning portion are arcuate recesses, and the detent portion is selectively engageable in the first positioning portion or in the second positioning portion; the driving head includes a neck portion protruding outwardly, the neck portion has a first toothed portion extending about the pivot axis, and the locking member includes a second toothed portion configured to mesh with the first toothed portion; the main body has a through hole disposed through opposite sides thereof, the control member is movably disposed in the through hole, and the through hole defines a center axis perpendicular to the pivot axis; the depth of the first positioning portion is less than the depth of the second positioning portion; the wrench further includes a shaft, the shaft is disposed through the main body and the driving head, and the shaft defines the pivot axis; the second stepped portion includes the first positioning portion and the second positioning portion.
